(19) United States
(12) Patent Application Publication
(10) Pub. No.: US 2004/0029432 A1
(43) Pub. Date: Feb. 12, 2004

(54) Sealing device for electrical plug connectors

(76) Inventors: Werner Denneler, Plochingen (DE); Thomas Ihring, Bondorf (DE); Uwe Steinhauser, Filderstadt (DE)

Correspondence Address: KENYON & KENYON, ONE BROADWAY, NEW YORK, NY, 10004, US

(21) Appl. No.: 10/416,071

(22) PCT Filed: Jul. 11, 2002
(86) PCT No.: PCT/DE02/02534

(30) Foreign Application Priority Data
Sep. 7, 2001 (DE) 101-43-957.1

(51) Int. Cl. H01R 4/24

(52) U.S. Cl. 439/426

(57) ABSTRACT

A sealing device for electrical plug connectors is configured in such a way that a favorable, cost-saving and functionally safe production of plug connectors, from a manufacturing point of view, is fulfilled. The plug connectors each have a contact carrier in a plug housing. Contact carrier is penetrated by accommodation chambers, which with one end each open out into one tub-shaped installation space of plug connector. These ends are covered by a restraining element, so that a sealing compound, which is free-flowing, curable and inserted into installation space, which is able to completely seal against contact elements that have been plugged through it, remains in the installation space. The sealing device for electrical plug connectors is provided especially for use in the automobile industry.

### FIELD OF THE INVENTION

The present invention relates to a sealing device for electrical plug connectors.

### BACKGROUND INFORMATION

German Published Patent Application No. 44 34 030 describes a sealing device and its use in an electrical plug connector. The plug connector has a housing which has a plurality of individual cables supplied to it, and is bundled as a wiring harness. Each cable is connected at one end to a connecting section of a contact element. The contact elements are supported in a contact carrier of the plug connector for making contact with mating contact elements. In order to protect the contact locations between the contact elements and the mating contact elements from corrosion, it is necessary to eliminate the possibility of water having access to the contact elements via the cables. To accomplish this, the contact elements connected to the cables, after being guided through a pressure plate, are guided through a sealing plate made of an elastic material. For this, the pressure plate and the sealing plate have a number of cutouts corresponding to the number of contact elements. By a pressing of the sealing plate through the pressure plate, the cables are enclosed and sealed with form locking.

As a result of the necessity of using a sealing plate with cutouts, this type of sealing is costly from a manufacturing point of view because the cutouts have to be applied to an elastic material, and therefore are difficult to work on. The cutouts may be damaged and made nonfunctional by guiding through contact elements having sharp edges. Furthermore, the number of cutouts must exactly match the number of contact elements.

Consequently, for each change of the number of contact elements, a newly adapted sealing plate has to be created. This results in small lot sizes in the manufacture of sealing plates, and costly stock keeping, which consequently makes the production of plug connectors more expensive.

Alternatively, unused cutouts have to be closed off by individual plugs, which is cumbersome and produces uncertainties with regard to seal tightness.

A sealing device thus designed leads to a plug connecter that is cost-intensive to make, and which has a performance reliability that is endangered by the installation procedure.

### SUMMARY OF THE INVENTION

In contrast, the sealing element of the present invention for an electrical plug device has the advantage that the above-mentioned shortcomings are prevented.

To accomplish this, the sealing device has a restraining element which allows the creation of an installation space in a plug housing of the plug connection which is usable for inserting a free-flowing, curable sealing substance.

This configuration allows use for most electrical plug connectors. In this context, it is important whether the contacts have sharp edges or special rounded surfaces, since the self-spreading sealing compound, being self-healing, is always completely sealing. This allows for a reduction in testing costs of the plug connector, and consequent manufacturing costs, while attaining great functional reliability.

### BRIEF DESCRIPTION OF THE DRAWING

FIG. 1 is a cross-sectional representation of a plug connector with a sealing device.

### DETAILED DESCRIPTION

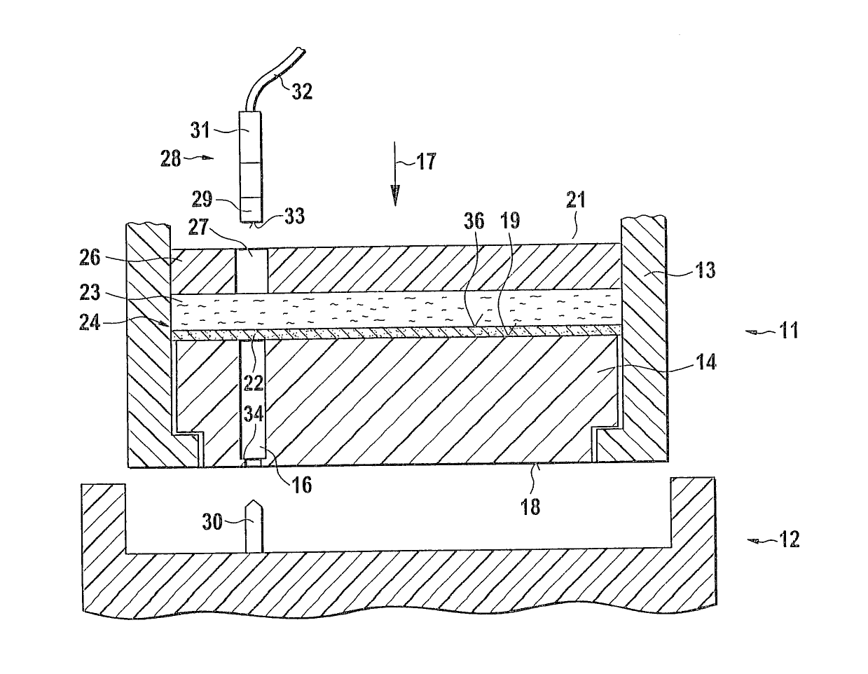

An electrical plug connector 11, as shown in FIG. 1, is part of an electrical plug connection. Plug connector 11 is configured as a portable wiring harness plug, and is connectible in a detachable manner to a stationary mating connector 12, illustrated only in the region of connection, as the other part of the plug connection.

Plug connector 11 has a frame-shaped plug housing 13 made of plastic. A contact carrier 14 made of plastic is inserted into plug housing 13, sealed on the circumference. Contact carrier 14 has a number of accommodation chambers 16 corresponding to the number of poles of plug connector 11, of which one is illustrated in FIG. 1.

Accommodation chambers 16 axially penetrate contact carrier 14, corresponding to a plug direction of plug connector 11 alongside an arrow 17, and extend as far as the end face at plug side 18 of plug connector 11, at which the connection to mating plug connector 12 occurs.

Facing away from plug side 18, accommodation chambers 16 open out on a component side 19 of contact carrier 14 into a tub-shaped installation space 21 of plug housing 13. Installation space 21 is lined at least in the area of component side 19 with a restraining element 22, so that accommodation chambers 16 are covered at their ends on this side.

Into installation space 21, a freely flowing, self-leveling, curable and then partially elastic sealing compound 23 is filled in. Sealing compound 23 and restraining element 22 together from a sealing device 24 for plug connector 11, and restraining element 22 functionally secures insertion of sealing compound 23 in plug connector 11.

Sealing compound 23 may have a pressure plate 26, which is mounted in installation space 21 following sealing compound 23, and then completely covers sealing compound 23, axially applied on top of the compound 23 with force locking.

Pressure plate 26, made of plastic, has a number of axially directed ducts 27 corresponding to the number of poles of plug connector 11, of which one is illustrated in FIG. 1.

Plug connector 11 is completed by the assembly of contact elements 28, of which each has a contact section 29 at a free end for contacting a mating contact element 30 of mating plug contact 12, and a connecting section 31 at the other end. A cable 32 is connected at connecting section 31 in an electrically conductive manner, which in FIG. 1 is illustrated only in the region of connection, and is a part of a wiring harness coming off plug connector 11.

The installation of contact elements 28 into plug housing 13 is performed in each case by placing ahead contact section 29 in a plugging procedure through assigned duct 27, sealing compound 23 and restraining element 22, all the way into accommodation chamber 16 up to a stop of front face 33 of contact element 28 at an inner shoulder 34 of accommodation chamber 16.

By locking elements that are generally known, contact elements 28 are secured, after a complete installation into accommodation chambers 16, in this functioning positioning, against being pulled out backwards from accommodation chambers 16, counter to the direction of arrow 17.

The protection of contact elements 28 from corrosion, which is able to be triggered particularly by letting in water along cables 32, is done by sealing device 24.

Sealing device 24 has, as a central functioning element, pourable, self-leveling sealing compound 23, which, when it is being poured into installation space 21, has to be prevented from flowing through accommodation chambers 16 of contact carrier 14. This prevention of flowing through is performed by restraining element 22, which may be configured in different manners, and which are mentioned here only in exemplary fashion.

Restraining element 22 may be made of a thin powder layer, which may have a platelet-type structure, so that a thin-layer, easily pushed-through closure of ducts 27 is possible. The materials for the powder layer may be talcum or mica, because these, having a platelet-type structure, are able to form a layer even in their thinnest application. These materials may be prepared to a high degree of fineness, so that when the contact elements are plugged through, the proportion of the powder used does not interfere with the contact making.

Furthermore, restraining element 22 may be a film. The film may be formed in a spraying application onto component side 19 of contact carrier 14, or may be a separate part laid into place.

An exemplary embodiment of the separate part is a thin cellular plastic insert having open cells. As a variant, the plastic foam insert may have a closed-cell cover surface 36 on one side, which faces away from sealing compound 23. This safely prevents the flowing away of sealing compound 23 through the cellular plastic insert.

The film may also be made of an elastomer like silicone rubber. In this context, based on a comparable chemical structure with the sealing compound, a good bonding is created between these substances.

In addition, the film may be made of a thermoplastic, such as polyethylene, polypropylene, polyethyleneteraphthalate, omposites thereof, or of layered films provided with fusion adhesives. In this context very thin films may be prepared which have a sufficient strength with regard to handling and at the same time a targeted low punch-through resistance when contact elements 28 are passed through.

Moreover, the film may be made of a high temperature-resistant plastic such as polytetrafluoroethylene or copolymers thereof. In this context, high reaction temperatures may be used for the rapid curing of free-flowing sealing compound 23.

Restraining element 22 may be a fiber material such as felt or paper, as a separate part. In spite of the compact nature of the fiber material, a rapid soaking with the free-flowing sealing compound 23 occurs, and consequently there is created a restraining element 22 that is easily pushed through.

The separate part may also be formed by a bulk material. The items in question here are particularly silicone rubber threads in the form of a random orientation (random goods) or as piece goods. The random orientation has the advantage that the production costs for restraining element 22 turn out to be particularly low.

Ball-shaped or other geometrically shaped particles made of silicone gel or silicone aerosols, which are applied by being blown or sprayed onto component side 19 of contact carrier 14 may be used. In this context, just as in the case of sealing compound 23, on account of the comparable chemical structure, a composite is created between the materials which inhibits the drag-out of particles when contact elements 28 are plugged through.

It is also possible to use soft, open-cell nonwoven fabrics or fiber stocks. These may be applied by blowing on or by separate production and being laid up on the component side 19 of contact carrier 14. In this context, these materials may be easy to soak when the compound is poured, and easy to pierce when contact elements 28 are plugged through, without they themselves being dragged-out.

Sealing compound 23, before curing, may partially dissolve restraining element 22, because then, after the curing of sealing compound 23, a mechanically stable sealing device 24 is developed.

Furthermore, it is also possible that restraining element 22 is formed by sealing compound 23 itself. For this purpose, sealing compound 23 is fastened in the edge zones via thermal influences, for example, by a shock-like heat application, during its application to component side 19 of contact carrier 14.

Finally, it is possible to develop restraining element 22 as several parts, and to lay these parts at least partially onto contact carrier 14 and on sealing compound 23. In this context, independently of the design of restraining element 22, a volumetrically accurate partial filling of installation space 21 may be accomplished. In connection with partially elastic sealing compound 23, using an equally great contact pressure of pressure plate 26, reproducible and functionally safe sealing relations may be produced in a uniform manner at plug connectors 11.

Consequently, the conditions for producing plug connectors 11 that are favorable, cost-saving and functionally safe, from a standpoint of production engineering, are fulfilled.

What is claimed is:

1. A sealing device for electrical plug connectors, of which at least ore has a plug housing (13) in which at least one contact carrier 14 is situated, which is penetrated by at least one accommodation chamber (16) for axially supporting a contact element (28), in the plug-in direction of the contact element (28) into the accommodation chamber (16), the contact element (28) at its end is connected, on the one hand, at a connecting section (31) to at least one cable (32), and on the other hand, in a contact section (29) is connectible to a mating contact element (30) of a mating plug connector (12), and the contact element (28), for its introduction into the accommodation chamber (16), is guided through a sealing device (24) which is at least partially insertable into an installation space (21) of the plug housing (13),
wherein the sealing device (24) is made up of a restraining element (22) and a free-flowing, curable sealing compound (23).

2. The sealing device as recited in claim 1,
wherein the restraining element (22) is made in one piece and lies at least partially on the contact carrier (14) in the installation space (21).

3. The sealing device as recited in claim 1,
wherein the restraining element (22) is made up of a plurality of parts and lies at least partially on the contact carrier (14) and on the sealing compound (23) in the installation space (21).

4. The sealing device as recited in one of claims 1 through 3,
wherein the restraining element (22) is made up of a powder layer.

5. The sealing device as recited in claim 4,
wherein the powder layer as the restraining element (22) has a platelet-shaped structure and is formed especially by talcum or mica of great fineness.

6. The sealing device as recited in one of claims 1 through 3,
wherein the restraining element (22) is made up of a film.

7. The sealing device as recited in claim 6,
wherein the film as the restraining element (22) is formed in a spray application or is embodied of an inserted, separate part.

8. The sealing device as recited in claim 7,
wherein the film as the restraining element (22) is made up of a cellular plastic insert.

9. The sealing device as recited in claim 8,
wherein the cellular plastic insert as the retraining element (22) is open-celled.

10. The sealing device as recited in claim 9,
wherein the cellular plastic insert as the restraining element (22) has a closed-cell cover surface (36) on one side which faces away from the sealing compound (23).

11. The sealing device as recited in claim 7,
wherein the film as the restraining element (22) is made of an elastomer such as silicone rubber, of a thermoplastic such as polyethylene, polypropylene, polyethylene terephthalate, of composites thereof, of layered films provided with fusion adhesives, or of a high temperature-resistant plastic such as polytetrafluoroethylene or copolymers thereof.

12. The sealing device as recited in claim 7,
wherein the part which embodies the restraining element (22) is a fiber material such as felt or paper.

13. The sealing device as recited in claim 7,
wherein the part which embodies the restraining element (22) is a bulk material such as silicone rubber threads, and is inserted into the installation space (21) as a random laid layer or cut.

14. The sealing device as recited in claim 1,
wherein the sealing compound (23) is an easily flowing, self-spreading, non-cross-linked gel or is formed by mixed gel components, and the sealing compound (23) is curable and partially elastic.

15. The sealing device as recited in one of the preceding claims,
wherein the sealing compound (23) partially dissolves the restraining element (22) before the curing.

16. The sealing device as recited in claim 1,
wherein the restraining element (22) is formed by the sealing compound (23) itself, and the sealing compound (23) is strengthened for this purpose, at least in edge zones, by thermal influences during insertion into the installation space (21).
